(19) United States
(12) Patent Application Publication
(10) Pub. No.: US 2023/0371779 A1
(43) Pub. Date: Nov. 23, 2023

(54) CLEANING METHOD AND CLEANING APPARATUS FOR DISHWASHER, AND DISHWASHER

(71) Applicant: FOSHAN SHUNDE MIDEA WASHING APPLIANCES MANUFACTURING CO., LTD., FOSHAN (CN)

(72) Inventors: Zhiheng FAN, FOSHAN (CN); Yongbing QUAN, FOSHAN (CN); Zhongke WEI, FOSHAN (CN); Wei CHEN, FOSHAN (CN); Caixia WANG, FOSHAN (CN)

(21) Appl. No.: 18/031,148

(22) PCT Filed: Jan. 11, 2022
(86) PCT No.: PCT/CN2022/071288

§ 371 Date: Apr. 11, 2023

(30) Foreign Application Priority Data
Jan. 11, 2021 (CN) 202110032057.X
Jan. 11, 2021 (CN) 202110032060.1

(51) Int. Cl. A47L 15/42; A47L 15/00; A47L 15/46; G06T 7/00

(52) U.S. Cl. CPC A47L 15/4295; A47L 15/0028; A47L 15/46; G06T 7/0002; A47L 2401/04; A47L 2501/30; A47L 2501/07; A47L 2501/06; A47L 2501/04

(57) ABSTRACT

A cleaning method and cleaning apparatus for a dishwasher, and a dishwasher. The cleaning method for a dishwasher includes acquiring a first image of tableware in a dishwasher, identifying the type of dirt on the tableware according to the first image, determining a corresponding washing mode according to the type of dirt, controlling the dishwasher to successively clean the tableware according to the washing mode, each time after the cleaning is completed, acquiring a second image of the tableware in the dishwasher, and comparing the first image with the second image, to determine the effectiveness of the washing mode. In this way, the problem in the prior art of it being impossible to accurately identify the type of dirt can be solved, and an appropriate washing mode is matched for the current type of dirt, to realize thorough cleaning, and less time is consumed, the efficiency is high, and less water energy and electric energy are used.

### CROSS-REFERENCES TO RELATED APPLICATIONS

The present disclosure is a national phase application of International Application No. PCT/CN2022/071288, filed on Jan. 11, 2022, which claims the benefits of Chinese patent applications No. 202110032060.1 and 202110032057.X, both filed on Jan. 11, 2021, the contents of which are incorporated herein by reference.

### FIELD

The present application relates to the field of kitchen appliances, in particular to a cleaning method for a dishwasher, a cleaning device for a dishwasher, and a dishwasher.

### BACKGROUND

With the improvement of living standards, increasingly dishwashers are used. The application of intelligence is increasingly extensive, and the corresponding requirements for dishwashers are also higher and higher.

In order to achieve more energy saving and more accurate and efficient cleaning, image recognition is usually used to cooperate with the existing cleaning method of a dishwasher. In the application of image recognition for dishwashing, first, it is necessary to recognize various characteristics of dishware and dirt, different washing modes are started according to the characteristics, several modes are usually preset, a corresponding washing mode is matched according to the characteristics, and cleaning is performed according to the matched washing mode. The above conventional cleaning method has the following disadvantages: in terms of image recognition, it is difficult for the image recognition to distinguish dirt attached to dishware from their own patterns on the dishware. It is difficult to achieve accuracy only by image recognition, resulting in an inaccurate washing mode that is subsequently matched, and it is difficult to determine the effectiveness of the washing mode, thus the final washing effect is not ideal.

### SUMMARY

To solve the above problems, embodiments of the present application are to provide a cleaning method for a dishwasher, a cleaning device for a dishwasher, and a dishwasher.

Embodiments of the present application provide a cleaning method for a dishwasher, including:
acquiring a first image of dishware within the dishwasher;
identifying a dirt type on the dishware according to the first image;
determining a corresponding washing mode according to the dirt type;
controlling the dishwasher to successively clean the dishware according to the washing mode;
acquiring a second image of the dishware within the dishwasher after each cleaning is completed;
comparing the first image with the second image to determine a removed dirt type; and
matching the removed dirt type with the washing mode to determine an effectiveness of the washing mode.

In the embodiment of the present application, the dirt type includes one of: a temperature sensitive type, a pressure sensitive type, and a detergent sensitive type.

In the embodiment of the present application, determining the corresponding washing mode according to the dirt type includes:
establishing a mapping relationship between the dirt type and a washing mode; and
determining a washing mode corresponding to the dirt type according to the mapping relationship,
and the washing mode includes any one of a detergent, temperature, and pressure.

In the embodiment of the present application, identifying the dirt type on the dishware according to the first image includes:
establishing a database based on pre-acquired dirt images and dirt type labels of the dirt images;
pre-training an image recognition model through the database; and
inputting the acquired first image into the pre-trained image recognition model and determining the dirt type.

In the embodiment of the present application, further including:
controlling the dishwasher to respectively clean the dishware within the dishwasher in at least one washing mode;
acquiring an image of the cleaned dishware;
determining whether a dirt on the cleaned dishware is removed according to the image;
switching the washing mode in response to that the dirt is not removed; and
controlling the dishwasher to clean the dishware in the switched washing mode.

In the embodiment of the present application, the washing mode includes any one of: adjusting a detergent, adjusting a washing temperature, and adjusting a washing pressure.

In the embodiment of the present application, further including:
determining the washing mode according to the image in response to that the dirt is removed; and
controlling the dishwasher to clean the dishware in the determined washing mode.

In the embodiment of the present application, determining the washing mode according to the image includes:
acquiring an image of the cleaned dishware;
determining a first characteristic of the dishware or a second characteristic of the dirt remaining on the dishware according to the image; and
determining an effective washing mode according to the first characteristic or the second characteristic, and a parameter of the effective washing mode includes any one of a washing speed, the washing time, a washing position, and a washing angle.

In the embodiment of the present application, the first characteristic includes at least one of: a number of dishware, and a dishware location; and the second characteristic includes at least one of: an area of a dirt, and a location of a dirt.

In the embodiment of the present application, determining the effective washing mode according to the first characteristic or the second characteristic includes:
acquiring an area corresponding to a dirt on the dishware; and
determining the washing time of the washing mode according to the area.

In the embodiment of the present application, determining the effective washing mode according to the first characteristic or the second characteristic includes:
acquiring a location of a dirt on the dishware; and
determining the washing position of the washing mode according to the location.

In some embodiments of the present application, provided is a cleaning device for a dishwasher, including:
an image acquisition device, configured to acquire an image of dishware;
a spray arm, configured to spray a cleaning medium to clean dishware in a washing area within the dishwasher; and
a processor, configured to perform the cleaning method for a dishwasher.

In some embodiments of the present application, provided is a dishwasher, including the cleaning device for a dishwasher.

In some embodiments of the present application, provided is a machine readable storage medium, the machine readable storage medium stores instructions that, when executed by a processor, cause the processor to perform the cleaning method for a dishwasher.

In some embodiments of the present application, provided is a computer program product, the computer program product includes a computer program that, when executed by a processor, cause the processor to perform the cleaning method for a dishwasher.

With the above solution, i.e., the cleaning method for the dishwasher, the first image is acquired, and the corresponding washing mode is formulated in advance according to the dirt type of the first image, the dishware is successively cleaned according to the washing mode, and the first image is compared with the second image, to determined the effectiveness of the washing mode; and in this way, the problem in the prior art that the dirt type cannot be accurately identified can be solved to match a current dirt type with an appropriate washing mode, to achieve thorough cleaning, short time consumption and high efficiency, and saving water energy and electric energy.

Additional the embodiments of the present application will be described in detail in the Detailed Description section that follows.

### BRIEF DESCRIPTION OF THE DRAWINGS

The accompanying drawings are used to provide a further understanding of the present application and constitute a part of the specification, and together with the Detailed Description below serve to explain the present application, but are not to be construed as limiting the present application. In the accompanying drawings:

FIG. 1A schematically shows a structural schematic diagram of a dishwasher according to an embodiment of the present application;

FIG. 1B schematically shows a front view of a structure of the dishwasher according to the embodiment of the present application;

FIG. 1C schematically shows a structural schematic diagram of a cleaning mechanism of the dishwasher according to the embodiment of the present application;

FIG. 1D schematically shows a structural schematic diagram of part of the cleaning mechanism in FIG. 1C;

FIG. 2 schematically shows a flow schematic diagram of a cleaning method for a dishwasher according to an embodiment of the present application;

FIG. 3 schematically shows a flow schematic diagram of a step S13 in the cleaning method for the dishwasher according to the embodiment of the present application;

FIG. 4 schematically shows a logic schematic diagram of the cleaning method for the dishwasher according to the embodiment of the present application;

FIG. 5 schematically shows a further flow schematic diagram of the cleaning method for the dishwasher according to the embodiment of the present application;

FIG. 6 schematically shows a flow schematic diagram of a step S16 in the cleaning method for the dishwasher according to the embodiment of the present application;

FIG. 7 schematically shows a flow schematic diagram of a step S162 in the cleaning method for the dishwasher according to the embodiment of the present application;

FIG. 8 schematically shows another flow schematic diagram of the step S162 in the cleaning method for the dishwasher according to the embodiment of the present application;

FIG. 9 schematically shows a flow schematic diagram of a cleaning method for a dishwasher according to another embodiment of the present application;

FIG. 10 schematically shows a flow schematic diagram of a step S22 in the cleaning method according to another embodiment of the present application;

FIG. 11 schematically shows a flow schematic diagram of a step S23 in the cleaning method according to another embodiment of the present application; and

FIG. 12 schematically shows a flow schematic diagram of a step S26 in the cleaning method according to another embodiment of the present application.

In the drawings: 100, cleaning device; 1, housing; 2, cleaning mechanism; 21, image acquisition device; 22, storage rack; 23, driving motor; 24, processor; 25, spray arm; 26, mounting bracket; and 251, water outlet hole.

### DETAILED DESCRIPTION OF THE DISCLOSURE

Embodiments of the present application will be described in detail below with reference to the accompanying drawings. It should be understood that the specific embodiments described herein are merely illustrative and explanatory of the present application, and are not intended to limit the present application.

It should be noted that if a directional indication (such as up, down, left, right, front, rear, . . . ) is involved in the embodiments of the present application, the directional indication is used only to explain the relative positional relationship, movement situation, etc. between the components in a specific attitude (as shown in the drawings), and if the specific attitude changes, the directional indication will also change accordingly.

In addition, the descriptions relating to “first”, “second”, etc. in this application are for descriptive purposes only, and are not to be understood as indicating or implying relative importance thereof or implicitly specifying the number of features indicated. Thus, features defined as “first” and “second” may explicitly or implicitly include at least one of the features. In addition, the meaning of “or” throughout is to include three parallel solutions, taking “A or B” as an example, including a solution A, or a solution B, or a solution in which both A and B are met.

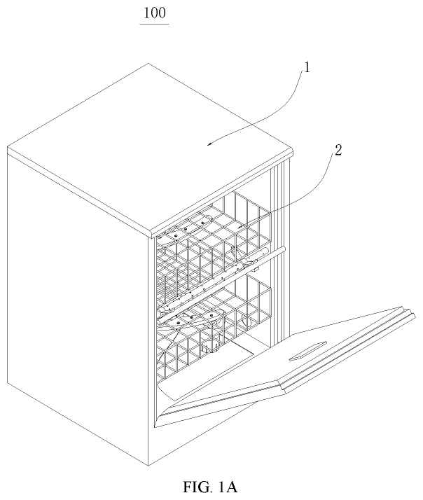

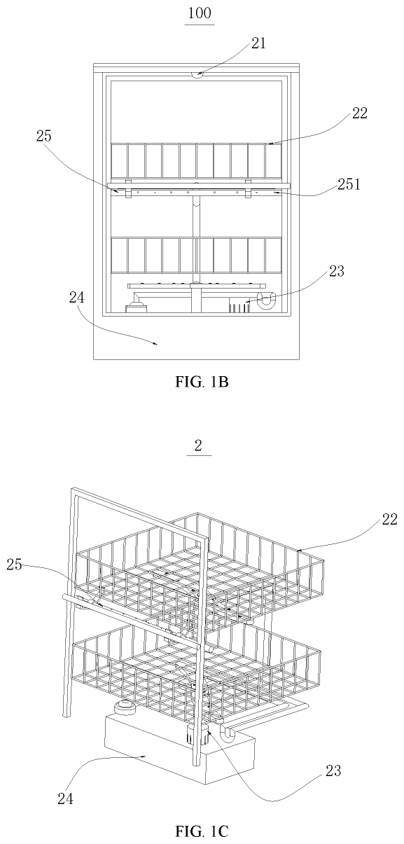

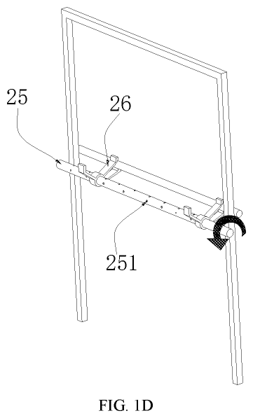

FIG. 1A schematically shows a structural schematic diagram of a dishwasher according to an embodiment of the present application, where a control method for a dishwasher according to an embodiment of the present application may be applied. FIG. 1B schematically shows a front view of a structure of the dishwasher according to the embodiment of the present application. It should be understood that FIGS. 1A and 1B show only one embodiment of a dishwasher 100 to more clearly describe a cleaning method provided in the present application, and are not intended to limit the appearances, locations, mounting modes, and connection relationships of components of the dishwasher, which are not related to the present application.

As shown in FIGS. 1A and 1B, the dishwasher 100 may include a housing 1 and a cleaning mechanism 2 disposed inside the housing 1. An outer contour of the housing 1 may include, but is not limited to, a rectangular shape, and a cylindrical shape.

The cleaning mechanism 2 may include an image acquisition device 21, a storage rack 22, a processor 24 and a spray arm 25.

The storage rack 22 (e.g. a bowl basket) may be fixed on the inner side the dishwasher 100 for accommodating dishware, and the image acquisition device 21 may include a camera or an image sensor (e.g. an infrared sensor). The image acquisition device 21 may be arranged in within the dishwasher 100. The processor 24 may be electrically connected with the image acquisition device 21.

The image acquisition device 21 may be configured to acquire an image within the dishwasher 100 and the processor 24 may be configured to process the acquired image.

For example, in one example, the image acquisition device 21 may acquire an image of the dishware on the storage rack 22 after dishware is placed on the storage rack 22. The processor 24 may acquire the image, and determine the characteristics of the dishware placed within the dishwasher 100 to control the spray arm 25 to clean the dishware according to the characteristics of the dishware.

Examples of the processor 24 may include, but are not limited to, a general-purpose processor, a special processor, a conventional processor, a digital signal processor (DSP), microprocessors, one or more microprocessors associated with a core of the DSP, a controller, a microcontroller, an application specific integrated circuit (ASIC), a field programmable gate array (FPGA) circuit, any other types of integrated circuits (ICs) and state machines, and the like.

In one example, the spray arm 25 may adopt a rotatable form.

FIG. 1C schematically shows a structural schematic diagram of a cleaning mechanism of the dishwasher according to the embodiment of the present application; and FIG. 1D schematically shows a structural schematic diagram of part of the cleaning mechanism in FIG. 1C. Referring to FIGS. 1B-1D, the cleaning mechanism 2 may further include a driving motor 23, and the driving motor 23 may be arranged on the lower side inside the dishwasher 100, or may be arranged on the back of the dishwasher 100, i.e., away from one side where a user places dishware. The driving motor 23 may be connected with the spray arm 25. The spray arm 25 is provided with water outlet holes 251 communicating with the inside of the spray arm 25, and the water outlet holes 251 may be formed at intervals in the spray arm 25, and the spraying range of the spray arm 25 is wider. In one example, the spray arm 25 may be of a cylinder shape, and the water outlet holes 251 are formed at intervals in an array in the section of the spray arm 25, and water sprayed out from the water outlet holes 251 is sprayed at an angle.

In the embodiment of the present application, the dishwasher 100 may further include a water pressure transmitter (not shown), a water heater (not shown), and a water valve (not shown). The water pressure transmitter and the water heater may be electrically connected to the processor 24, and the water pressure transmitter, the water heater and the water valve may be connected with and communicate with the inside of the spray arm 25. Connections between the spray arm 25 and the water pressure transmitter, the water heater, the water valve, and the driving motor 23 may be direct connections, or may be indirect connections through intermediate parts.

The water valve may be configured to control the water outlet amount of the sprayed water, the water pressure transmitter may be configured to control the water outlet pressure, the water heater may be configured to control the water outlet temperature, and the driving motor 23 may be configured to drive the spray arm 25 to rotate. In one example, the spray arm 25 may be arranged at the central position inside the dishwasher. The central position may be defined as the middle position of storage racks 22 in the dishwasher 100, and when the spray arm 25 rotates, dishware on the storage racks 22 can be covered, to save the internal space of the dishwasher 100. The dishware on the storage racks 22 can be sprayed only by one single spray arm 25, and a larger use space is brought in while the design and material cost is saved.

The water valve, the water pressure transmitter, the water heater, and the driving motor 23 may be controlled by the processor 24. For example, a region, where dishware is placed, of the storage rack 22 may be divided into four quadrants, i.e., first, second, third, and fourth quadrants. The processor 24 can control the driving motor 23 to drive the spray arm 25 to rotate, and the water outlet holes 251 face any one of the four quadrants. In addition, the processor 24 can also control the water valve to adjust the water outlet amount of the water outlet holes 251 (or stop water outlet).

In the embodiment of the present application, the driving motor 23 can also drive the spray arm 25 to translate. When the spray arm 25 can translate, the dishwasher 100 may also include a conversion mechanism (not shown), and the conversion mechanism is connected between the driving motor 23 and the spray arm 25, and can convert rotation of the driving motor 23 into translation of the spray arm 25.

In the embodiment of the present application, the storage rack 22 may include one or more layers of storage racks, e.g., upper and lower layers of storage racks. In an example of two layers of storage racks shown in the drawing, the spray arm 25 may be positioned at the middle position of two storage racks 22, and when the spray arm 25 rotates, all dishware on the two storage racks 22 can be sprayed.

In the embodiment of the present application, the dishwasher 100 may also include a mounting bracket 26, and the spray arm 25 is rotatably connected to the mounting bracket 26. The position of the mounting bracket 26 is fixed, and the spray arm 25 can rotate relative to the mounting bracket 26. There is no limitation to the mode of fixing the position of the mounting bracket 26, and for example, the mounting bracket 26 may be fixedly connected to the storage rack 22 or other positions.

In summary, the structural features of the dishwasher 100 provided by the embodiment of the present application may achieve the following functions:
1. The spray arm 25 is driven by the driving motor 23 for movement, including rotation and translation, and the spray arm 25 can spray a cleaning medium to clean dishware in a washing area within the dishwasher.
2. Image acquisition is performed on the dishware in the washing area within the dishwasher by the image acquisition device 21, and the image is not limited to an image of the dishware or an image of a dirt.

The above are the basic structure and functions of the dishwasher provided by the embodiment of the present application. Other structures are not described yet, and are further supplemented by the method embodiment hereafter. The same or equivalent improvements made to the above structures the embodiments of the present application still fall within the scope of protection of the embodiments of the present application.

An embodiment of the present application also provides a cleaning method for a dishwasher, and the cleaning method is an integral embodiment. There are solutions in this embodiment, including various aspects of image recognition of dishware in the washing area of the dishwasher, selection of a washing mode, and configuration of the washing mode. The contents contained in the cleaning method are described in detail below.

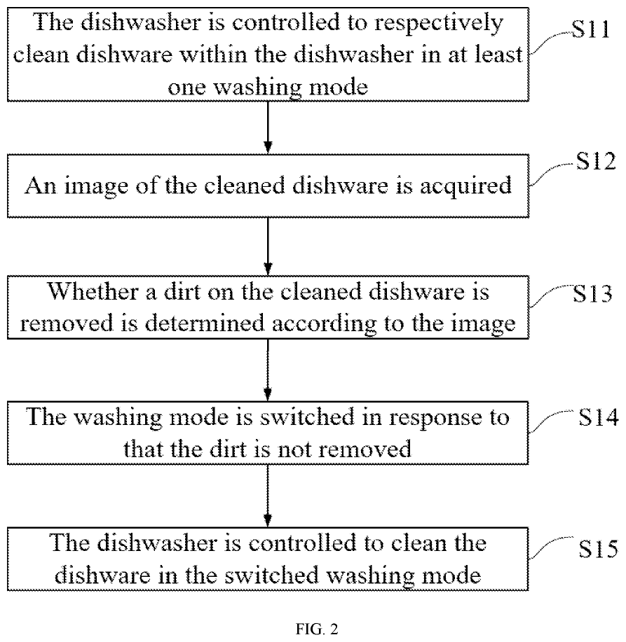

Referring to FIG. 2, FIG. 2 schematically shows a flow schematic diagram of a cleaning method for a dishwasher according to an embodiment of the present application. An embodiment of the present application includes a method for selection and configuration of a washing mode in a cleaning method for a dishwasher. In one embodiment of the present application, a cleaning method for a dishwasher is provided. In particular, provided is a method for spraying by the spray arm of the dishwasher described above, and this method aims at solving the problem that the existing dishwasher only sprays in a fixed mode, when the spray arm sprays a cleaning medium, the cleaning is finished at the set washing time, no matter whether a dirt on dishware may be washed off, for example, some sticky rice balls, steamed egg custards, and pastes are difficult to wash off in a fixed mode, resulting in the failure to achieve the user's expected experience effect.

The cleaning method provided by the embodiment of the present application is realized by the structure of the dishwasher described above. The term “cleaning medium” mentioned above may be clean water provided by allowing the spray arm to communicate with a municipal water supply end or a cleaning solution in which other cleaning substances are mixed. The cleaning method includes:
Step S11, the dishwasher is controlled to respectively clean dishware within the dishwasher in at least one washing mode;
Step S12, an image of the cleaned dishware is acquired;
Step S13, whether a dirt on the cleaned dishware is removed is determined according to the image;
Step S14, the washing mode is switched in response to that the dirt is not removed; and
Step S15, the dishwasher is controlled to clean the dishware in the switched washing mode.

In step S11, washing modes may be preconfigured by coding in a processor of the dishwasher, and each washing mode can treat one dirt type corresponding to the washing mode. The washing mode is mainly set based on the washing sensitivity of different dirt types on the dishware.

The dirt type may include, but is not limited to: a detergent sensitive type, a temperature sensitive type, and a pressure sensitive type. Accordingly, the washing modes provided in the embodiment of the present application may include: a washing mode A, adjusting a detergent; a washing mode B, adjusting the washing temperature; a washing mode C, adjusting the washing pressure; and a washing mode D, a default washing mode.

It can be understood that the detergent sensitive type dirt can be, for example, a viscous lipid or oil dirt, the temperature sensitive type dirt can be, for example, an oil dirt, and the pressure sensitive type dirt can be, for example, vegetable leaves, bones, soup, steamed egg custards, pastes, or the like attached to dishware. With respect to washing modes in which the washing mode A, the washing mode B, and the washing mode C are broad categories, it is possible to continue to subdivide the washing mode A to include a washing mode A1, a washing mode A2, and a washing mode A3. The washing mode A1, the washing mode A2, and the washing mode A3 differ in the type or the dosage of a detergent. Similarly, the washing mode B may include a washing mode B1, a washing mode B2, and a washing mode B3 at different washing temperatures. Correspondingly, the washing mode C may be a washing mode C1, a washing mode C2, a washing mode C3 or the like at different pressures. The washing mode D is a washing mode in which a cleaning medium is clean water or a default washing solution at an initial pressure and an initial temperature.

In an implementation of step S11, step S11 may include: the dishwasher is first controlled to clean dishware within the dishwasher in a default washing mode.

It can be understood that in most cases, the dishwasher can clean a dirt on the dishware clean in the default washing mode. Since the default washing mode is conducted at a temperature and a pressure, there is not a dirt on the dishware that is not cleaned clean every time, so a normal process is to perform cleaning by the dishwasher in the default washing mode D, acquire an image of the cleaned dishware, and determine that the dirt on the cleaned dishware is removed according to the image, thus ending the cleaning.

When other dirt are present on the dishware, such as sticky pastes on the dishware, the default washing mode is switched with other washing modes after cleaning in the default washing mode is completed. A manner in which the default washing mode is switched with the other washing modes may be successive switch of washing modes or random non-repetitive switch of washing modes. For example, cleaning is successively performed in the washing mode A1 and the washing mode A2 for a preset time, such as once every 5 s. Whether the dirt are removed is determined once after each cleaning. Until the dirt are removed, the current washing mode is deemed to be effective, and the current washing mode is continued to be used to achieve complete removal of the dirt.

Hence, in one embodiment, the step S11 may include:
the dishware is first cleaned by the default washing mode;
the washing modes are successively switched or the washing modes are randomly (not repeatedly) upon receiving an instruction to switch the washing mode; and
the dishwasher is controlled to perform cleaning according to each washing mode for a preset time and then stopped.

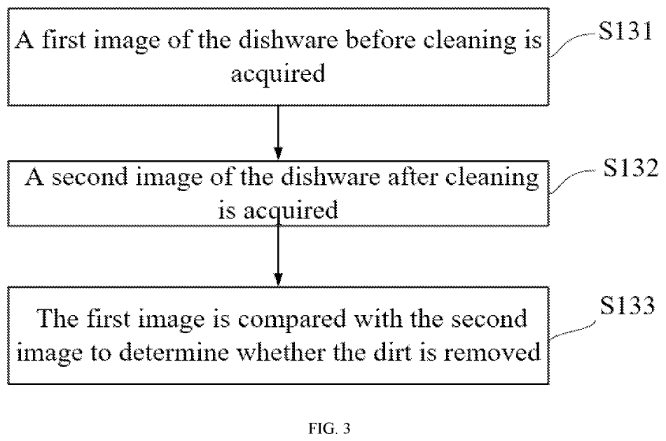

Referring to FIG. 3, FIG. 3 schematically shows a flow schematic diagram of a step S13 in the cleaning method for the dishwasher according to the embodiment of the present application. The step S12 may acquire the image of the cleaned dishware, and the image is used during performing the step S13, namely determining whether a dirt on the cleaned dishware is removed according to the image. It should be noted that reference to whether the dirt is removed in the embodiment of the present application means that the dirt has a sign of being washed off, and is not limited to being completely washed clean.

The step S13 may include the following ways:
Step S131, a first image of the dishware before cleaning is acquired;
Step S132, a second image of the dishware after cleaning is acquired; and
Step S133, the first image is compared with the second image to determine whether the dirt is removed.

Comparing the first image and the second image may be that: image data of the first image and the second image are read before and after cleaning, respectively, the first image and the second image are converted to gray (256 gray scale image), the characteristics of the dirt on the dishware in the first image and the second image are identified by the boundary feature method, and the contours of the dirt are segmented according to edge characteristics of the dirt (this step is to take into account that during the cleaning process, the dirt may be at other positions in the washing area other than the dishware, or the dishware may shake, resulting in a difference between the first image and the second image, rather than a difference caused by the fact that the dirt is washed off, resulting in misjudgment), a first contour of the dirt in the first image and a second contour of the dirt in the second image are extracted, respectively, and the first contour and the second contour are compared to determine whether the dirt is reduced to determine whether the dirt is removed.

In one embodiment, the comparison of the first contour and the second contour may be a pixel histogram comparison to determine whether the dirt is removed by observing whether pixels of the dirt are changed.

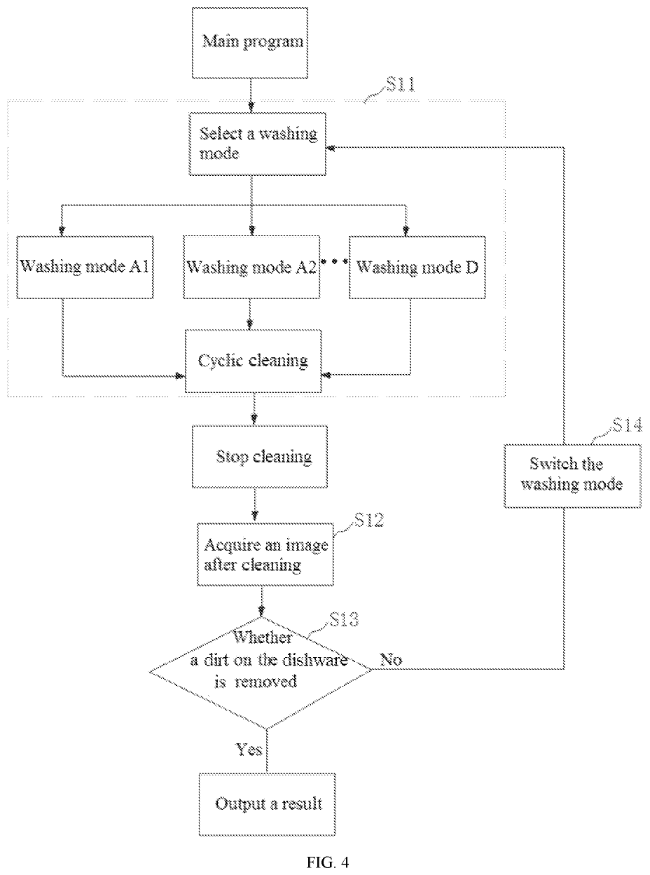

Referring to FIG. 4, FIG. 4 schematically shows a logical schematic diagram of the cleaning method for the dishwasher according to the embodiment of the present application; it is stated in step S14 and step S15 that in the event that the dirt is not removed, the current washing mode is ineffective for the dirt type corresponding to the dirt. By executing the switched washing mode, the dishwasher is controlled to clean the dishware in the switched washing mode. By repeatedly performing step S14 and step S15, it is possible to achieve thorough cleaning of the dishware. In the event that the dirt on the dishware is cleaned clean, cleaning is ended, achieving a better cleaning effect and giving users a better experience.

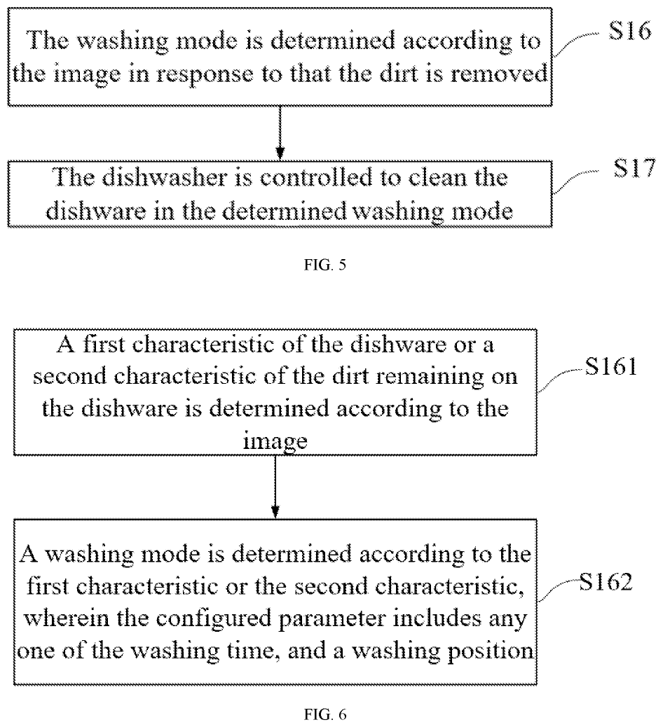

On the other hand, referring to FIG. 5, FIG. 5 schematically shows a further flow schematic diagram of the cleaning method for the dishwasher according to one embodiment; and in the embodiment of the present application, the cleaning method further includes:

Step S16, the washing mode is determined according to the image in response to that the dirt is removed; and

Step S17, the dishwasher is controlled to clean the dishware in the determined washing mode.

Steps S16 and S17 may be understood as that after the dirt is removed, this washing mode is then considered effective, when the washing mode is determined to be effective for the dirt after cleaning is performed for a predetermined period of time, the step S14 is not performed, i.e., the washing mode is not switched, and the effective washing mode is configured, the configuration includes any one of the washing time, and a washing position, and the dishware is cleaned according to the determined washing mode after the configuration.

Referring to FIG. 6, FIG. 6 schematically shows a flow schematic diagram of a step S16 in the cleaning method for the dishwasher according to the embodiment of the present application. In the embodiment of the present application, the step S16, the washing mode is determined according to the image, including:

Step S161, a first characteristic of the dishware or a second characteristic of the dirt remaining on the dishware is determined according to the image; and

Step S162, a washing mode is determined according to the first characteristic or the second characteristic, and a parameter of the effective washing mode includes any one of the washing time, and a washing position.

To further elaborate steps S161 to S162, referring to FIG. 1D, when cleaning is performed in the washing mode, i.e., the step S11 is performed, all the water outlet holes 251 in the spray arm 25 may be opened first, the rotation speed of the spray arm 25 may be constant, and other parameters such as water pressure and temperature may be constant, in order to test the effectiveness of the washing mode only with the washing mode being a variable. However, in the subsequent official cleaning, in order to perform cleaning faster and more efficiently, the washing mode may be further configured according to the first characteristic of the dishware and the second characteristic of the dirt, to speed up the cleaning efficiency.

In the embodiment of the present application, the first characteristic may include at least one of: the number of dishware, a material of dishware, and a dishware location; it can be understood that the “number” of dishware can be obtained by target extraction and analysis based on the image of the dishware, such as extraction of the contours of dishware, or may be input by a user. The dishware “location” may be obtained from the washing position in the dishwasher where the contour of the image of the dishware falls, for example, by establishing a coordinate system in the washing area of the dishwasher, the coordinate position of the image of the dishware, i.e. the dishware location is obtained. Further, the image of the dishware is subjected to grayscale binarization and the parts of the dishware with the dirt are separated out by local threshold separation, and the area and location of the dirt are calculated. Further, the washing time of this washing mode can be configured by the number of dishware: the greater the number of dishware, the longer the cleaning time, to ensure thoroughness of cleaning.

In the embodiment of the present application, it is also possible to configure the cleaning range of the washing mode by the dishware location, for example, the water outlet holes used in the dishwasher are configured. By using the water outlet hole corresponding to the dishware location to spray a cleaning medium, the other water outlet holes are closed, and the other water outlet holes do not spray the cleaning medium, to achieve water energy saving and concentrated cleaning.

In the embodiment of the present application, the second characteristic includes at least one of: an area of a dirt, and a location of a dirt. Depending on the area of the dirt and/or the location of the dirt, the washing mode may also be configured and the cleaning efficiency is higher.

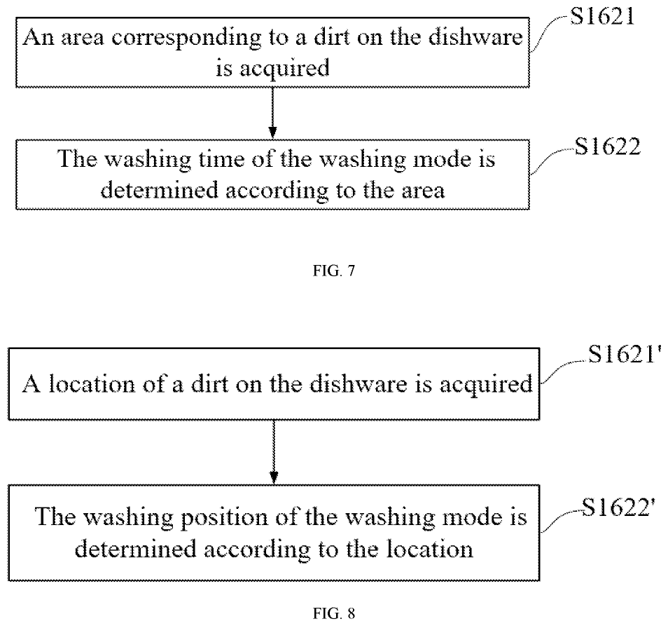

Referring to FIG. 7, FIG. 7 schematically shows a flow schematic diagram of a step S162 in the cleaning method for the dishwasher according to the embodiment of the present application. In step S162, the effective washing mode is determined according to the first characteristic or the second characteristic, including:
Step S1621, an area corresponding to a dirt on the dishware is acquired; and
Step S1622, the washing time of the washing mode is determined according to the area.

It can be understood that after grayscale binarization of the image of the dishware, each dirt type is extracted as a contour. Based on the dirt area of a black pixel reflected by the dirt, the washing time of the washing mode that needs to be configured is obtained. In one example, the washing time of the washing mode can be configured: 1. by grayscale binarization of the image of the dishware; 2. by separating out the parts of the dishware with the dirt through local threshold separation; 3. by calculating the area of the dirt; and 4. by setting the corresponding washing time according to the area. In particular, the user may set a threshold value, the washing time is a first time when the area of the dirt is within the threshold value, and the washing time is a second time when the area of the dirt exceeds the threshold value, that is, it is considered difficult to clean, at this time, the current time is set as the second time.

Referring to FIG. 8, FIG. 8 schematically shows another flow schematic diagram of the step S162 in the cleaning method for the dishwasher according to the embodiment of the present application. In step S162, the effective washing mode is determined according to the first characteristic or the second characteristic, including:
Step S1621′, a location of a dirt on the dishware is acquired; and
Step S1622′, the washing position of the washing mode is determined according to the location.

In the embodiment of the present application, the cleaning range of the washing mode may be configured by the location of the dirt, the water outlet holes used are configured, the cleaning medium is sprayed at the water outlet hole corresponding to the dirt location, and the other water outlet holes are closed; and thus, water energy saving and concentrated washing are achieved.

In summary, the embodiment of the present application provides the cleaning method, in particular the method for spraying by the spray arm of the dishwasher described above. The method finds a washing mode in which dirt can be thoroughly cleaned by controlling the dishwasher to respectively clean dishware within the dishwasher in at least one washing mode. The embodiment of the present application aims to solve the problem that the existing dishwasher sprays in a fixed mode, when the spray arm sprays a cleaning medium, the cleaning is finished at the set washing time, no matter whether a dirt on dishware may be washed off, for example, some sticky rice balls, steamed egg custards, and pastes are difficult to wash off in a fixed mode, resulting in the failure to achieve the user's expected product experience effect, to improve the thoroughness of cleaning, and the user's use experience.

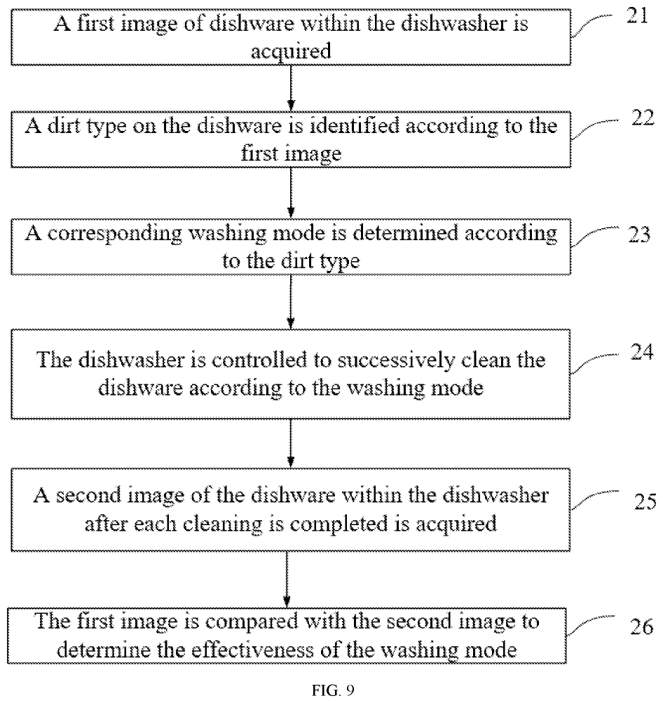

Referring to FIG. 9, FIG. 9 schematically shows a flow schematic diagram of a cleaning method for a dishwasher according to another embodiment of the present application. An embodiment of the present application includes an image recognition method in a cleaning method for a dishwasher. In another embodiment of the present application, provided is a cleaning method for a dishwasher, in particular, a method for spraying by the spray arm of the dishwasher described above, and this method is an improvement based on the above method. On the basis of the selection of the washing mode and the configuration of the washing mode, in the embodiment of the present application, the dirt type can also be identified based on the image of the dishware in the dishwasher, and the effectiveness of the washing mode is determined by comparing the images before and after cleaning.

In another embodiment of the present application, provided is an improved cleaning method, the cleaning method may include:
Step S21, a first image of dishware within the dishwasher is acquired;
Step S22, a dirt type on the dishware is identified according to the first image;
Step S23, a corresponding washing mode is determined according to the dirt type;
Step S24, the dishwasher is controlled to successively clean the dishware according to the washing mode;
Step S25, a second image of the dishware within the dishwasher after each cleaning is completed is acquired; and
Step S26, the first image is compared with the second image to determine the effectiveness of the washing mode.

In step S21, a first image of dishware that is not yet cleaned within the dishwasher is first acquired, for example, by an image acquisition device disposed in the dishwasher. In one example, the first image may be triggered to be acquired at the beginning of cleaning, and this method may be achieved by editing the job properties of the image acquisition device. The step S21 is a common means and will not be elaborated too much.

In order to more clearly illustrate the cleaning method of step S21 to step S25 according to the embodiment of the present application, a cleaning method in the conventional manner of the dishwasher and the disadvantages thereof are explained first:
in order to achieve more energy saving and more accurate and efficient cleaning, image recognition is usually used to cooperate with the existing cleaning method of a dishwasher. In the application of image recognition for dishwashing, first, it is necessary to recognize various characteristics of dishware and dirt, and different washing modes are started according to the characteristics. In general, several modes are preset for the dishwasher, a corresponding washing mode is matched according to the characteristics, and cleaning is performed according to the matched washing mode. The above conventional cleaning method has the following disadvantages: in terms of image recognition, it is difficult for the image recognition to distinguish dirt attached to dishware from their own patterns on the dishware. It is difficult to achieve accuracy only by image recognition, resulting in an inaccurate washing mode that is subsequently matched, and it is difficult to determine the effectiveness of the washing mode, thus the final cleaning effect is not ideal.

Accordingly, according to the cleaning method provided by the embodiment of the present application, the first image of the dishware within the dishwasher is first acquired, a washing mode is selected based on the first image, the dishware is controlled to be cleaned in the washing mode, and the first image and the second image before and after washing are compared, to determine the effectiveness of the washing mode.

In the above step S22, washing modes may be preconfigured by coding in a processor of the dishwasher, and each washing mode can treat one dirt type corresponding to the washing mode. The washing mode is mainly set based on the washing sensitivity of different dirt types on the dishware, and the dirt type may include: a detergent sensitive type, a temperature sensitive type, and a pressure sensitive type.

Accordingly, the washing modes provided in the embodiment of the present application may include: a washing mode A, adjusting a detergent; a washing mode B, adjusting the washing temperature; a washing mode C, adjusting the washing pressure; and a washing mode D, a default mode.

It can be understood that the detergent sensitive type dirt can be, for example, a viscous lipid or oil dirt, the temperature sensitive type dirt can be, for example, an oil dirt, and the pressure sensitive type dirt can be, for example, vegetable leaves, bones, soup, steamed egg custards, pastes, or the like attached to dishware. With respect to washing modes in which the washing mode A, the washing mode B, and the washing mode C are broad categories, it is possible to continue to subdivide the washing mode A to include a washing mode A1, a washing mode A2, and a washing mode A3. The washing mode A1, the washing mode A2, and the washing mode A3 differ in the type or the dosage of a detergent. Similarly, the washing mode B may include a washing mode B1, a washing mode B2, and a washing mode B3 at different washing temperatures. Correspondingly, the washing mode C may be a washing mode C1, a washing mode C2, a washing mode C3 or the like at different pressures. The washing mode D is a fixed washing mode.

In one embodiment of the present application, the steps S21 to S23 preliminarily formulate a combination of washing modes required for cleaning by identifying the dirt type on the dishware within the dishwasher through the image.

It can be understood that in step S22, the dirt type on the dishware is identified according to the first image. Since a pattern may exist on the dishware, the dirt is difficult to segment out, and the dirt type identified from the first image may be inaccurate, identifying the dirt type on the dishware according to the first image is a blurring algorithm for selecting only a few washing modes, which has the advantage of being more efficient and faster than running all washing modes in sequence.

In order to more clearly describe the steps S21 to S24, in one example, the dirt type on the dishware may be identified as a1 and b1 according to the first image, and it is possible to preliminarily formulate a combination of washing modes required for cleaning as the washing mode A1 and the washing mode B1 by the step S23. In one embodiment, the washing mode A1 corresponds to the dirt type a1 and the washing mode B1 corresponds to the dirt type b1, the dishware within the dishwasher is cleaned by the washing mode A1 and the washing mode B1 in the same manner as in the above-described embodiment, and the dishware within the dishwasher may be washed by the washing mode A1 and the washing mode B1 successively, for example, cleaning is conducted in the washing mode A1 for 5 s followed by cleaning in the washing mode B1 for 5 s. After cleaning in the washing mode A1 is completed, the dishware is subjected to image recognition once to determine whether there is a sign that the dirt type a1 is removed, and if the dirt type a1 is removed, the washing mode A1 is identified as an effective washing mode. Similarly, the dishware is subjected to image recognition once after cleaning in the washing mode B1 is completed, and whether the washing mode B1 is effective is determined in the same step.

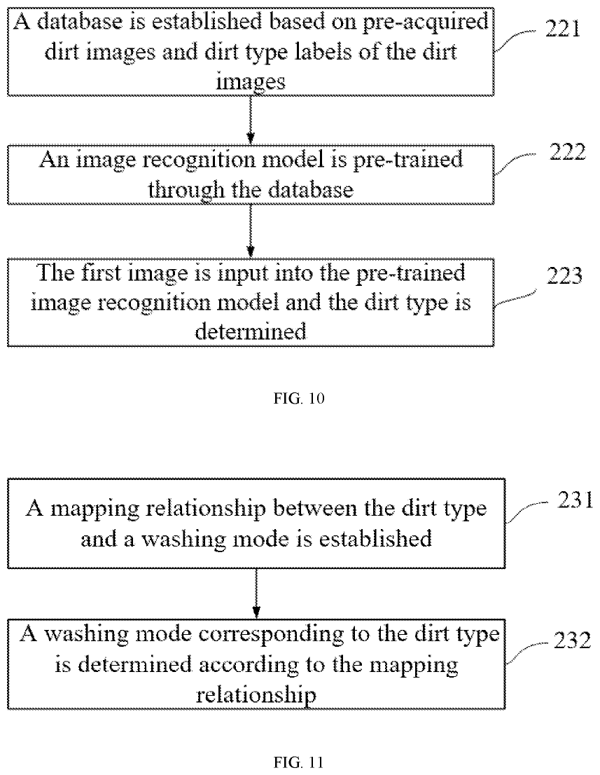

Referring to FIG. 10, FIG. 10 schematically shows a flow schematic diagram of a step S22 in the cleaning method according to another embodiment of the present application. Step S22, identifying the dirt type on the dishware according to the first image may include:
Step S221, a database is established based on pre-acquired dirt images and dirt type labels of the dirt images;
Step S222, an image recognition model is pre-trained through the database; and
Step S223, the first image is input into the pre-trained image recognition model and the dirt type is determined.

It can be understood that a processor of the dishwasher may pre-acquire some dirt images, as well as dirt type labels, such as a label: oil stain, to perform model pre-training on the pre-created image recognition model. The image recognition model may be a neural network model or other models. During actual use, each time a user places dishware, the dishwasher may be triggered to acquire an image of the dishware in the washing area of the dishwasher, and input the first image thereof to the pre-trained image recognition model and determine the dirt type.

Further, the dirt images and the dirt type labels of the dirt images may be built into a cloud database. In one embodiment, the acquired first image may also be uploaded to the cloud database through a mobile communication network as a training sample for the image recognition model to increase the accuracy of recognition.

It can be understood that by connecting the dishwasher to the cloud database through the mobile communication network, a dirt image practically taken by each user will be uploaded to the cloud database as a training sample for the image recognition model, and the image recognition model is continuously updated to improve the accuracy of the image recognition model. After a period of time, the cloud may download the updated image recognition model into a dishwasher of each user side through OTA (OTA: Over-the-Air Technology), to improve the recognition accuracy of the dishwasher to give the user a better experience.

Referring to FIG. 11, FIG. 11 schematically shows a flow schematic diagram of a step S23 in the cleaning method according to another embodiment of the present application. Determining the required washing mode according to the dirt type in step S23 includes:
Step S231, a mapping relationship between the dirt type and a washing mode is established;
Step S232, a washing mode corresponding to the dirt type is determined according to the mapping relationship.

It can be understood that a processor of the dishwasher may establish a mapping relationship between the dirt type and the washing mode in a corresponding database, for example, the washing mode A1 corresponds to the dirt type a1, and the washing mode B1 corresponds to the dirt type b1. By inputting the dirt type identified in step S22 as a Key value to the database, the corresponding washing mode is matched according to the dirt type by the mapping relationship.

In step S25, i.e. after cleaning, the second image of the dishware may be identified. The second image is used to determine whether the dirt type corresponding to the washing mode is washed off after cleaning in step S26.

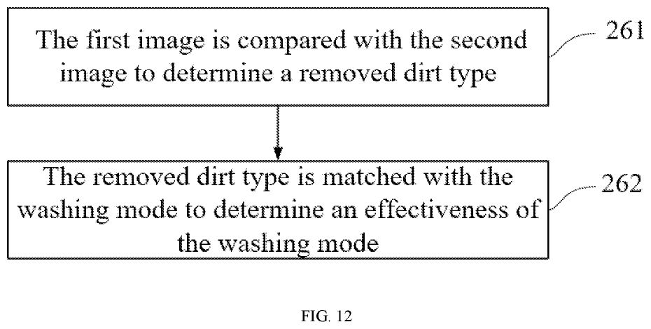

Referring to FIG. 12, FIG. 12 schematically shows a flow schematic diagram of a step S26 in the cleaning method according to another embodiment of the present application. Step S26, comparing the first image with the second image to determine the effectiveness of the washing mode may include:
Step S261, the first image is compared with the second image to determine a removed dirt type; and
Step S262, the removed dirt type is matched with the washing mode to determine an effectiveness of the washing mode.

It can be understood that by comparing the first image with the second image, it is possible to analyze the removed dirt type after cleaning. The dirt type is determined by the recognition from the first image by the step S22, and the removed dirt type is matched with the washing mode to determine the effectiveness of the washing mode, i.e., secondary determination of step S23.

For a better understanding of the above contents, it is assumed that the dirt type of an area on the dishware is identified from the first image before cleaning as the dirt type b1, and the dirt type b1 corresponds to a temperature sensitive type of oil stain. At this time, the dirt type b1 identified according to the first image during performing the step S22 is not necessarily correct, which is only a result of preliminary recognition, the above-described dirt type b1 is matched with the washing mode B1 during performing the step S23, the washing mode B1 must however be for the temperature sensitive type dirt b1, therefore, after cleaning in the washing mode B1 in step S24, if the area corresponding to the dirt type b1 on the dishware is found to be removed by comparing the first image with the second image, it is determined that the removed dirt type is the dirt type b1, i.e. the effectiveness of the washing mode B1 is determined. If it is found that the area corresponding to the dirt type b1 on the dishware is not thoroughly removed by comparing the first image with the second image, it is determined that the effectiveness of the current washing mode B1 is low, and the current washing mode corresponding to the dirt type needs to be changed.

In summary, in the embodiments of the present application, the first image is acquired, and the corresponding washing mode is formulated in advance according to the dirt type of the first image, the dishware is successively cleaned according to the washing mode, and the first image is compared with the second image to determine the effectiveness of the washing mode, in this way, the problem in the prior art that the dirt type cannot be accurately identified to find a suitable washing mode can be solved, to achieve thorough cleaning, short time consumption and high efficiency, and saving water energy and electric energy.

An embodiment of the present application also provides a cleaning device, the cleaning device may include:
an image acquisition device, configured to acquire an image of dishware;
a spray arm, configured to spray a cleaning medium to clean dishware in a washing area within a dishwasher; and
a processor, configured to perform the cleaning method for a dishwasher described above.

In particular, the processor may be configured to:
acquire a first image of dishware within the dishwasher;
identify a dirt type on the dishware according to the first image;
determine a corresponding washing mode according to the dirt type;
control the dishwasher to successively clean the dishware according to the washing mode;
acquire a second image of dishware within the dishwasher after each cleaning in the washing mode is completed;
compare the first image with the second image to determine a removed dirt type; and
match the removed dirt type with the washing mode to determine an effectiveness of the washing mode.

In the embodiment of the present application, the dirt type may include at least one of:
a temperature sensitive type, a pressure sensitive type, and a detergent sensitive type.

In the embodiment of the present application, the processor may be further configured to:
establish a mapping relationship between the dirt type and a washing mode; and
determine a washing mode corresponding to the dirt type according to the mapping relationship;
and the washing mode includes any one of a detergent, temperature, and pressure.

In the embodiment of the present application, the processor may be further configured to:
establish a database based on pre-acquired dirt images and dirt type labels of the dirt images;
pre-train an image recognition model through the database; and
input the first image into the pre-trained image recognition model and determining the dirt type.

In the embodiment of the present application, the processor may be further configured to:
control the dishwasher to respectively clean the dishware within the dishwasher in at least one washing mode;
acquire an image of the cleaned dishware;
determine whether a dirt on the cleaned dishware is removed according to the image;
switch the washing mode in response to that the dirt is not removed; and
control the dishwasher to clean the dishware in the switched washing mode.

In the embodiment of the present application, the washing mode may include any one of: adjusting a detergent, adjusting a washing temperature, and adjusting a washing pressure; and
the dirt type includes at least one of: a temperature sensitive type, a pressure sensitive type, and a detergent sensitive type.

In the embodiment of the present application, the processor may be further configured to:
acquire an image of the cleaned dishware;
determine a first characteristic of the dishware or a second characteristic of the dirt remaining on the dishware according to the image;
determining an effective washing mode according to the first characteristic or the second characteristic, and the configuring includes any one of a washing speed, the washing time, a washing position, a washing angle, and a washing range; and
clean the dishware in the determined washing mode.

In the embodiment of the present application, the first characteristic may include at least one of: a number of dishware, and a dishware location; and the second characteristic may include at least one of: an area of a dirt, and a location of a dirt.

In the embodiment of the present application, the processor may be further configured to:
acquire an area corresponding to a dirt on the dishware; and
determine the washing time of the effective washing mode according to the area.

In the embodiment of the present application, the processor may be further configured to:
acquire a location of a dirt on the dishware; and
determine a washing position of the effective washing mode according to the location.

With the above embodiments, the first image is acquired, and the corresponding washing mode is formulated in advance according to the dirt type of the first image, the dishware is successively cleaned according to the washing mode, and the first image is compared with the second image, to determine the effectiveness of the washing mode; and in this way, the problem in the prior art that the dirt type cannot be accurately identified can be solved to match a current dirt type with an appropriate washing mode, to achieve thorough cleaning, short time consumption and high efficiency, and saving water energy and electric energy.

If the method or the cleaning device of the present application is simply changed, the functions added to the method described above are combined, or replacement is performed on the device, such as replacement of the models and materials of the components, replacement of the use environment, simple replacement of the position relationships of the components, and the like; or the formed product thereof is integrally formed; or detachably designed; where the combined components may form a method/device/apparatus having a specific function, it is also within the protection scope of the present application to replace the method and device of the present application with such a method/device/apparatus.

An embodiment of the present application also provides a dishwasher, including the cleaning device described above. It should be understood that the dishwasher is not limited in size or contour, but only needs to utilize corresponding elements of the cleaning device to perform the same or similar function, which should also fall within the protection scope of the present application.

The cleaning device further includes a memory, the cleaning method for the dishwasher described above may be stored in the memory as a program unit, and the above-described program unit stored in the memory is executed by the processor to realize corresponding functions.

The processor includes a core that retrieves a corresponding program unit from the memory. One or more cores may be provided, and by adjusting the parameters of the cores, the spray arm of the dishwasher is controlled to clean the dishware according to the image of the dishware.

The memory may include forms such as a volatile memory, a random access memory (RAM) or a non-volatile memory in a computer readable medium, such as a read-only memory (ROM) or a flash RAM, and the memory includes at least one memory chip.

An embodiment of the present application also provides a machine readable storage medium, the machine readable storage medium stores instructions that, when executed by a processor, cause the processor to perform the cleaning method for a dishwasher.

An embodiment of the present application further provides a processor configured to run a program, and when the program runs, the cleaning method for a dishwasher is performed.

An embodiment of the present application also provides a computer program product, the computer program product includes a computer program that, when executed by a processor, cause the processor to perform the cleaning method for a dishwasher described above.

The embodiments of the present application may be provided as a method, a system, or a computer program product. Therefore, the present application may adopt a form of a full hardware embodiment, a full software embodiment, or a software and hardware combined embodiment. Furthermore, the present application may adopt a form of a computer program product implemented on one or more computer available storage mediums (including, but not limited to, a disk memory, a compact disc read-only memory (CD-ROM), an optical memory, etc.) including a computer available program code therein.

The present application is described with reference to the flow diagram and/or the block diagram of the method, the device (system), and the computer program product according to the embodiments of the present application. It should be understood that each flow and/or block in the flow diagram and/or the block diagram and a combination of the flows and/or blocks in the flow diagram and/or the block diagram may be implemented by computer program instructions. These computer program instructions may be provided to a processor of a general-purpose computer, a special purpose computer, an embedded processor or other programmable data processing devices to generate a machine, and the instructions executed by the processor of the computer or other programmable data processing devices generate an apparatus for achieving the functions specified in one or more flows of the flow diagram and/or one or more blocks in the block diagram.

These computer program instructions may also be stored in a computer readable memory to guide the computer or other programmable data processing devices to work in a specific mode, and the instructions stored in the computer readable memory generate a manufacture including an instruction apparatus. The instruction apparatus achieves the functions specified in one or more flows of the flow diagram and/or one or more blocks in the block diagram.

These computer program instructions may also be loaded to the computer or other programmable data processing devices, and a series of operation steps are executed on the computer or other programmable data processing devices to generate processing implemented by the computer, and accordingly, the instructions executed on the computer or other programmable data processing devices provide steps for achieving the functions specified in one or more flows of the flow diagram and/or one or more blocks in the block diagram.

In a typical configuration, a computing device includes one or more central processing units (CPUs), an input/output interface, a network interface, and a memory.

The memory may include forms of a volatile memory, a RAM and/or a nonvolatile memory in a computer readable medium, such as a ROM or a flash RAM. The memory is an example of the computer readable medium.

The computer readable medium includes nonvolatile, volatile, mobile, and non-mobile media and can implement information storage by any method or technology. Information may be a computer readable instruction, a data structure, a module of a program or other data. Examples of a storage medium of a computer include, but are not limited to, a phase-change random access memory (PRAM), a static random access memory (SRAM), a dynamic random access memory (DRAM), other types of RAMs, a ROM, an electrically erasable programmable read-only memory (EEPROM), a flash memory or other memory technologies, a CD-ROM, a digital versatile disc (DVD) or other optical memories, a cassette type magnetic tape, a magnetic tape disk memory or other magnetic storage devices, or any other non-transmission mediums, which can be used for storing information to be accessed by the computing device. According to the definition herein, the computer readable medium does not include transitory media, such as modulated data signals and carriers.

It should also be noted that terms such as “comprise”, “include” or any other variations thereof are intended to cover non-exclusive inclusion, and a process, method, commodity or device including a series of elements not only includes these elements, but also includes other elements which are not explicitly listed, or also includes inherent elements of such process, method, commodity or device. In case of no more limitations, an element defined by the statement “comprise one” is not exclusive of a case that there are other same elements in the process, method, commodity or device including the element.

1. A cleaning method for a dishwasher, comprising:
acquiring a first image of dishware within the dishwasher;
identifying a dirt type on the dishware according to the first image;
determining a corresponding washing mode according to the dirt type;
controlling the dishwasher to successively clean the dishware according to the washing mode;
acquiring a second image of the dishware within the dishwasher after each washing is completed;
comparing the first image with the second image to determine a removed dirt type; and
matching the removed dirt type with the washing mode to determine an effectiveness of the washing mode.

2. The cleaning method according to claim 1, wherein the dirt type comprises one of:
a temperature sensitive type, a pressure sensitive type, and a detergent sensitive type.

3. The cleaning method according to claim 1, wherein determining the corresponding washing mode according to the dirt type comprises:
establishing a mapping relationship between the dirt type and a washing mode; and
determining a washing mode corresponding to the dirt type according to the mapping relationship,
wherein the washing mode comprises any one of a detergent, temperature, and pressure.

4. The cleaning method according to claim 1, wherein identifying the dirt type on the dishware according to the first image comprises:
establishing a database based on pre-acquired dirt images and dirt type labels of the dirt images;
pre-training an image recognition model through the database; and
inputting the first image into the pre-trained image recognition model and determining the dirt type.

5. The cleaning method according to claim 1, further comprising:
controlling the dishwasher to respectively wash the dishware within the dishwasher in at least one washing mode;
acquiring an image of the washed dishware;
determining whether a dirt on the washed dishware is removed according to the image;
switching the washing mode in response to that the dirt is not removed; and
controlling the dishwasher to clean the dishware in the switched washing mode.

6. The cleaning method according to claim 5, wherein the washing mode comprises any one of: adjusting a detergent, adjusting a washing temperature, and adjusting a washing pressure.

7. The cleaning method according to claim 6, further comprising:
determining the washing mode according to the image in response to that the dirt is removed; and
controlling the dishwasher to clean the dishware in the determined washing mode.

8. The cleaning method according to claim 7, wherein determining the washing mode according to the image comprises:
acquiring an image of the washed dishware;
determining a first characteristic of the dishware or a second characteristic of the dirt remaining on the dishware according to the image; and
determining an effective washing mode according to the first characteristic or the second characteristic, wherein a parameter of the effective washing mode comprises any one of a washing speed, washing time, a washing position, and a washing angle.

9. The cleaning method according to claim 8, wherein
the first characteristic comprises at least one of: a number of dishware, and a dishware location; and
the second characteristic comprises at least one of: an area of a dirt, and a location of a dirt.

10. The cleaning method according to claim 8, wherein determining the effective washing mode according to the first characteristic or the second characteristic comprises:
acquiring an area corresponding to a dirt on the dishware; and
determining the washing time of the washing mode according to the area.

11. The cleaning method according to claim 8, wherein determining the effective washing mode according to the first characteristic or the second characteristic comprises:
acquiring a location of a dirt on the dishware; and
determining the washing position of the washing mode according to the location.

12. A washing device for a dishwasher, comprising:
an image acquisition device, configured to acquire an image of dishware;
a spray arm, configured to spray a washing medium to clean dishware in a washing area within the dishwasher; and
a processor, configured to perform the washing method for a dishwasher according to claim 1.

13. A dishwasher, comprising the washing device for a dishwasher according to claim 12.

14. A machine readable storage medium, the machine readable storage medium stores instructions that, when executed by a processor, cause the processor to:
acquire a first image of dishware with a dishwasher;
identify a dirt type on the dishware according to the first image:
determine a corresponding washing mode according to the dirt type,
control the dishwasher to successively clean the dishware according to the washing mode;
acquire a second image of the dishware within the dishwasher after each washing is completed;
compare the first image with the second image to determine a removed dirt type; and
match the removed dirt type with the washing mode to determine an effectiveness of the washing mode.

15. A computer program product, the computer program product comprises a computer program that, when executed by a processor, cause the processor to:
acquire a first image of dishware within a dishwasher;
identify a dirt type on the dishware according to the first image,
determine a corresponding washing mode according to the dirt type;
control the dishwasher to successively clean the dishware according to the washing mode;
acquire a second image of the dishware within the dishwasher after each washing is completed;
compare the first image with the second image to determine a removed dirt type; and
match the removed dirt type with the washing mode to determine an effectiveness of the washing mode.
